(19) United States
(12) Patent Application Publication
(10) Pub. No.: US 2015/0358990 A1
(43) Pub. Date: Dec. 10, 2015

(54) Interference Coordination Between Access Nodes Operating on a Shared Frequency Band

(71) Applicant: NOKIA SOLUTIONS AND NETWORKS OY, Espoo (FI)

(72) Inventors: Istvan Zsolt KOVACS, Aalborg (DK); Niels JORGENSEN, Aalborg (DK); Frank FREDERIKSEN, Klarup (DK)

(21) Appl. No.: 14/759,425

(22) PCT Filed: Jan. 15, 2013
(86) PCT No.: PCT/EP2013/050651

§ 371 Date: Jul. 7, 2015

(51) Int. Cl. H04W 72/12; H04W 24/02; H04W 16/14; H04L 5/00

(52) U.S. Cl. CPC H04W 72/1231; H04L 5/0073; H04W 24/02; H04W 16/14; H04W 84/045

(57) ABSTRACT

Interference coordination is used between neighbouring evolved NodeBs operating on a shared frequency band in a wireless communications network. Improved capacity estimation may be obtained by determining a capacity estimate of an access node of the wireless communications network on the basis of the interference co-ordination. Traffic may be steered with improved accuracy on the basis of the determined improved capacity estimate.

### FIELD

The present invention relates to estimation of available capacity in a wireless communication communications system and more particularly to estimation of capacity when interference coordination is performed in a wireless communications network.

### BACKGROUND

Mobile communications networks are typically optimised according to coverage and capacity. Planning tools support this task based on theoretical models but for both problems measurements must be derived in the network. Call drop rates give a first indication for areas with insufficient coverage, traffic counters identify capacity problems.

Modern telecommunications networks, such as High-Speed Packet Access (HSPA) networks according to the 3^{rd} Generation Partnership Project (3GPP) Long Term Evolution (LTE) and LTE-Advanced (LTE-A) Rel-10 specifications, provide coverage via evolved NodeBs (eNBs). Typically the eNBs provide coverage areas on multiple frequency bands, such as on the 900 MHz frequency band and on the 2100 MHz frequency band, thereby providing a macro layer coverage area and a micro layer coverage area respectively. Coverage areas and capacity of existing networks may be increased by deploying eNBs providing micro layer, or even smaller pico layer, coverage areas. However, when the number of pico layer and micro layer eNBs is increased, also interference between cells of the eNBs using the same frequency layer increases.

Mobile devices will usually connect automatically to the frequency layer offering the strongest signal. This can lead to imbalances with one layer fully loaded while another frequency is under-used. Not only can this create congestion, but the operator's network investments sit under-utilised.

### BRIEF DESCRIPTION

The following presents a simplified summary of the invention in order to provide a basic understanding of some aspects of the invention. This summary is not an extensive overview of the invention. It is not intended to identify key/critical elements of the invention or to delineate the scope of the invention. Its sole purpose is to present some concepts of the invention in a simplified form as a prelude to a more detailed description that is presented later.

Various embodiments comprise method(s), apparatus(es), a computer program product and a system as defined in the independent claims. Further embodiments are disclosed in the dependent claims.

According to an aspect of the invention there is provided a method comprising performing interference coordination between at least two access nodes operating on a shared frequency band in a wireless communications network, determining a capacity estimate of an access node of the wireless communications network on the basis of the interference co-ordination, and allocating traffic on the basis of the determined capacity estimate.

According to another aspect of the invention there is provided an apparatus comprising at least one processor, and at least one memory including computer program code, the at least one memory and the computer program code configured to, with the at least one processor, cause the apparatus at least to perform a method according to an aspect.

According to another aspect of the invention there is provided an apparatus comprising means configured to perform a method according to an aspect.

According to another aspect of the invention there is provided a computer program product comprising executable code that when executed, cause execution of functions of a method according to an aspect.

According to another aspect of the invention there is provided a system comprising one or more apparatuses according to an aspect.

Although the various aspects, embodiments and features of the invention are recited independently, it should be appreciated that all combinations of the various aspects, embodiments and features of the invention are possible and within the scope of the present invention as claimed.

Some embodiments may provide improved capacity estimation when interference coordination is used between neighbouring evolved NodeBs operating on a shared frequency band.

Further advantages will become apparent from the accompanying description.

### BRIEF DESCRIPTION OF THE DRAWINGS

In the following the invention will be described in greater detail by means of preferred embodiments with reference to the accompanying drawings, in which

FIG. 1 illustrates an architectural view of a wireless communications system according to an embodiment;

FIG. 2 illustrates a block diagram of an apparatus according to an embodiment;

FIG. 3 illustrates a method of determining available capacity of an access node on a shared frequency band, when more than one neighbouring access nodes use the same frequency band, according to an embodiment; and

FIG. 4 illustrates adjustment of the available capacity estimates at neighbouring access nodes, when interference coordination on a shared frequency band is used between the access nodes, according to an embodiment.

### DETAILED DESCRIPTION

Example embodiments of the present invention will now be described more fully hereinafter with reference to the accompanying drawings, in which some, but not all embodiments of the invention are shown. Indeed, the invention may be embodied in many different forms and should not be construed as limited to the embodiments set forth herein; rather, these embodiments are provided so that this disclosure will satisfy applicable legal requirements. Although the specification may refer to “an”, “one”, or “some” embodiment(s) in several locations, this does not necessarily mean that each such reference is to the same embodiment(s), or that the feature only applies to a single embodiment. Single features of different embodiments may also be combined to provide other embodiments. Like reference numerals refer to like elements throughout.

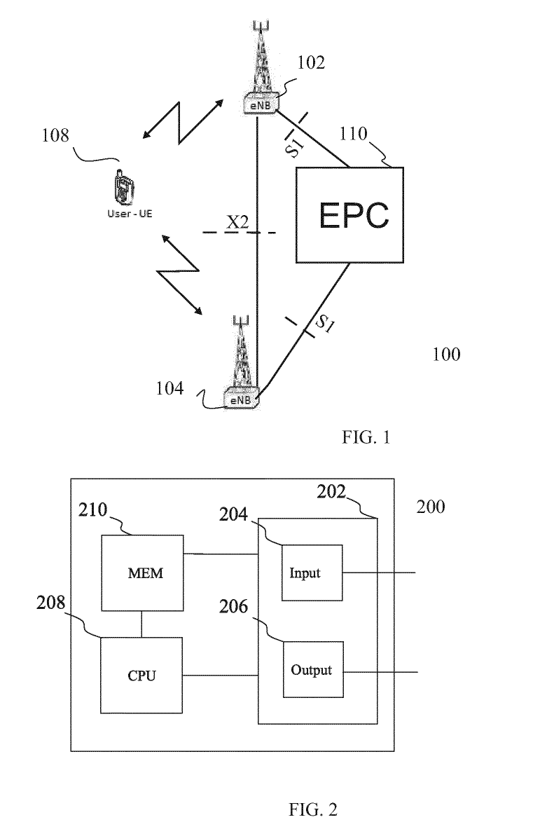

FIG. 1 illustrates an architectural view of a wireless communications system 100 deploying access nodes 102, 104 that communicate on a wireless frequency band with one or more UE 108 on a shared frequency band according to an embodiment. The access nodes connect to a backhaul of the wireless communications network, which provides a gateway for connections between the UE towards other networks, e.g. the Internet, and subscription management of the UE. The access nodes may also connect with each other for executing handovers of UE and possible data transfer of UE from an old access node to the new access node in the handover.

The access nodes may comprise neighbouring access nodes, whereby their respective coverage areas are adjacent or overlapping at least partly. It is also possible that the coverage area of node access node is essentially within the coverage area of the other access node. This is typical, when capacity is added by to an already deployed network by deploying a new access node within the coverage area of an already deployed access node with a large wireless coverage area. The new access node may have a smaller coverage area due to the large area coverage already being provided by the already deployed access node. When neighbouring access nodes operate on the shared frequency band, they may cause interference to each other. Typically the interference is high in the edges of the coverage area of an access node, where UE communicating with the access node experiences interference from the neighbouring access node operating on the shared frequency band.

Examples of wireless communications systems comprise a Global System for Mobile Communications (GSM) network, 3^{rd} generation mobile communications (3G) network, Long Term Evolution (LTE) network and LTE-advanced (LTE-A). In the following the embodiments will be explained in the context and using the terminology of 3GPP LTE-A Release 10 specifications.

In this context the network backhaul may be referred to as Evolved Packet Core (EPC) and the access nodes as eNBs. Typically the EPC comprises a Mobility Management Entity (MME) and System Gateway (S-GW). The MME connects to UE on a control plane connection over an S1 interface and may perform various tasks including e.g. location tracking of the UE, control of set up and release of UE connections, and subscription profile management of the UE. The S-GW manages tunnels for traffic of the UE between the eNB and other networks.

The eNBs are connected by a standardised X2 interface that provides transfer of messages and UE data between the eNBs. The messages may comprise messages of interference coordination between the eNBs.

An eNB may have one or more frequency bands of operation with respective coverage areas. The frequency bands may be separated in frequency, thereby including non-contiguous frequency bands, for example frequency bands around different carrier frequencies, such as frequency bands around an 800 MHz carrier and a 2600 MHz carrier.

It should be appreciated that, in a typical deployment scenario of eNBs in a wireless communications network, a frequency band on a lower carrier frequency has in practice less capacity compared to a frequency band on a higher frequency 2600 MHz, due to lower bandwidth and/or larger coverage area. Accordingly, eNBs operating on a higher frequency band, e.g. the 2600 MHz band, may be used to complement a coverage area of an already deployed eNB that may operate on a lower frequency band. Then, the coverage areas of the previously deployed eNB and the complementing eNB may overlap at least partly, or the whole coverage area of the complementing eNB may be within the coverage area of the previously deployed eNB.

The eNBs operating on the shared frequency band may provide different sizes of coverage areas. A coverage area may comprise a geographical coverage area, where radio frequency transmissions from the eNB may be received by UE. The eNBs may be categorised to different layers of the wireless communications network on the basis of the coverage area they provide. These layers may then be used in network planning as is conventional. Examples of the layers include a macro layer, micro layer, pico layer and a femto layer in decreasing order of their respective coverage areas. The eNBs of different layers of the wireless communications network are designed, constructed and deployed for the specific layer of operation. That is, the eNBs of different layers may for instance and not limited to: have different transmit powers, use different transmit/receive antennas, be deployed indoor or outdoor, use different antenna height, etc. Typically eNBs providing higher coverage area uses higher transmission power to enable communications over a large area. With decreasing coverage area, also the transmission power used by the eNB is decreased, since the eNB communicates with UE that are more close to it.

In an embodiment, at least one of the eNBs that operate on a shared frequency band also operates on a different frequency band than the shared frequency band. Accordingly, the eNB may operate on different frequency bands and thereby on different layers of the wireless communications network. In this way the eNB may provide different sizes of coverage areas. The different frequency band may be on a lower frequency band than the shared frequency band. In one example, the lower frequency band provides a macro layer coverage area. The shared frequency band may be on a higher frequency band and provide a smaller coverage area, for example a pico layer coverage area.

A logical unit representing a frequency band of an eNB may be referred to a cell. Data and signalling may be communicated between the eNB and the UE within a coverage area of the eNB.

FIG. 2 illustrates a block diagram of an apparatus 200 according to an embodiment. The apparatus may comprise a base station for example an eNB of an LTE-A network. Although the apparatus has been depicted as one entity, different modules and memory may be implemented in one or more physical or logical entities. The apparatus may be a terminal suitable for operating as a termination point for telecommunication sessions.

The apparatus 200 comprises an interfacing unit 202, a central processing unit (CPU) 208, and a memory 210, that are all being electrically interconnected. The interfacing unit comprises an input 204 and an output unit 206 that provide, respectively, the input and output interfaces to the apparatus. The input and output units may be configured or arranged to send and receive data and/or messages according to one or more protocols used in the above-mentioned communication standards. The memory may comprise one or more applications that are executable by the CPU.

The CPU may comprise a set of registers, an arithmetic logic unit, and a control unit. The control unit is controlled by a sequence of program instructions transferred to the CPU from the memory. The control unit may contain a number of micro-instructions for basic operations. The implementation of micro-instructions may vary, depending on the CPU design. The program instructions may be coded by a programming language, which may be a high-level programming language, such as C, Java, etc., or a low-level programming language, such as a machine language, or an assembler. The electronic digital computer may also have an operating system, which may provide system services to a computer program written with the program instructions. The memory may be a volatile or a non-volatile memory, for example EEPROM, ROM, PROM, RAM, DRAM, SRAM, firmware, programmable logic, etc.

An embodiment provides a computer program embodied on a distribution medium, comprising program instructions which, when loaded into an electronic apparatus, cause the CPU to perform according to an embodiment of the present invention.

The computer program may be in source code form, object code form, or in some intermediate form, and it may be stored in some sort of carrier, which may be any entity or device capable of carrying the program. Such carriers include a record medium, computer memory, read-only memory, electrical carrier signal, telecommunications signal, and software distribution package, for example. Depending on the processing power needed, the computer program may be executed in a single electronic digital computer or it may be distributed amongst a number of computers.

The apparatus 200 may also be implemented as one or more integrated circuits, such as application-specific integrated circuits ASIC. Other hardware embodiments are also feasible, such as a circuit built of separate logic components. A hybrid of these different implementations is also feasible. When selecting the method of implementation, a person skilled in the art will consider the requirements set for the size and power consumption of the apparatus 200, necessary processing capacity, production costs, and production volumes, for example.

In an embodiment the input unit may provide circuitry for obtaining data, signalling, signalling messages and/or transmissions to the apparatus. The obtaining may comprise receiving radio frequency signals from an antenna, for example. In another example the obtaining may comprise receiving baseband signals from an RF unit or a wired communications interface, e.g. an Ethernet interface. Accordingly, data, signalling, signalling messages and transmissions in embodiments of the present disclosure may be provided as RF signals or baseband signals.

In an embodiment the output unit may provide circuitry for transmitting data, signalling, signalling messages and/or transmissions from the apparatus. The transmitting may comprise transmitting radio frequency signals from an antenna, for example. In another example the transmitting may comprise transmitting baseband signals to an RF unit or a wired communications interface, e.g. an Ethernet interface. Accordingly, data, signalling, signalling messages and transmissions in embodiments of the present disclosure may be provided as RF signals or baseband signals.

In an embodiment the interfacing unit provides communications for coordinating interference between eNBs. The interference may be coordinated using an interference coordination mechanism. The communications may comprise receiving messages including information of interference coordination and sending messages including information of interference coordination. The information of interference coordination may comprise information of interference coordination on a shared frequency. The information of interference coordination may comprise information of muted resources on a shared frequency band. It should be noted that the muting of resources can be in the form of partly muting and completely muting, depending on the specific implementation. The muted resource blocks may comprise time frames on the shared frequency band, for example as in TDM-eICIC of the 3GPP Release 10 specifications as discussed below.

In an embodiment the interfacing unit provides the communications by implementing an X2 interface, where information related to interference coordination is communicated between eNBs using X2 Application Protocol. The X2 Application protocol may be implemented according to 3GPP TS 36.423 V11.2.0 (2012-09) Technical Specification 3rd Generation Partnership Project; Technical Specification Group Radio Access Network; Evolved Universal Terrestrial Radio Access Network (E-UTRAN); X2 application protocol (X2AP), (Release 11), for example. Then the information of interference coordination may be communicated in a Load Information message that includes an Almost Blank Subframes (ABS) Information Element (IE), as described in Section 8.3.1.2 of the TS 36.423.

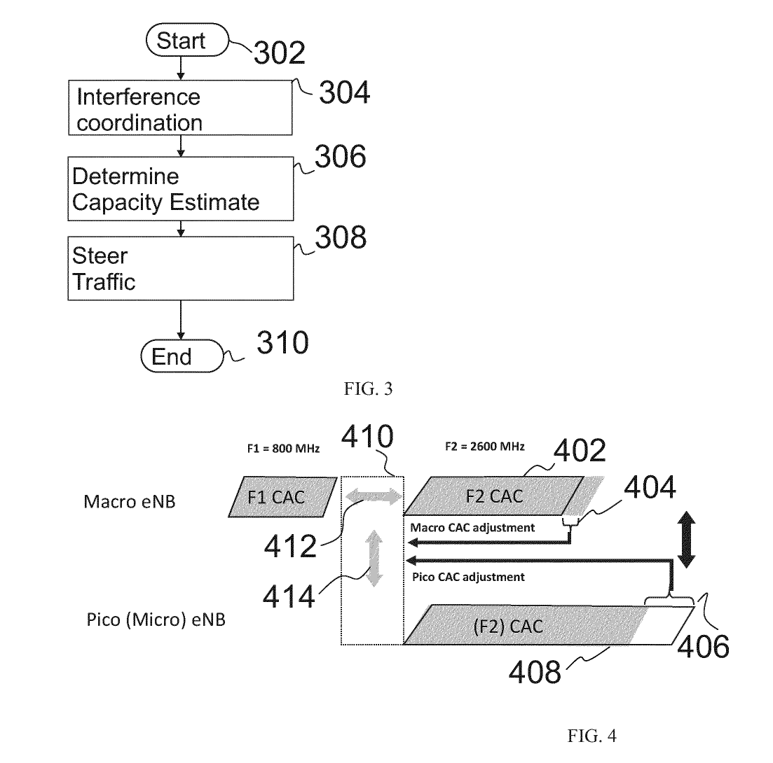

FIG. 3 illustrates a method of determining available capacity of an access node on a shared frequency band, when more than one neighbouring access nodes use the same frequency band. In the following the method is described using the context of LTE-A. The method may be implemented by an eNB according to FIG. 2. The eNB may be operating in the communications system illustrate d in FIG. 1.

The method starts in 302, where an eNB is operational for radio frequency communications over an air-interface towards one or more UE. The communications typically comprises transmitting control messages at defined time instants. In the context of 3GPP networks, for example LTE and LTE-A, this control information may comprise System Information messages.

The eNB is connected by wired or wireless communications interface to one or more other neighbouring eNBs that operate on the same frequency band. Thereby, the frequency band used by the at least two eNBs, is shared between the eNBs. The communications interface may be an X2 interface. When an eNB is operational it may estimate usage of its resources on a frequency band it is operating. The eNB may have one or more operational frequency bands, e.g. a shared frequency band and further frequency bands which may be shared or dedicated to the eNB. The resources may comprise combinations of frequency, time and codes. The estimate may comprise an estimate of available resources, i.e. an estimate of available capacity on a specific frequency band.

A single unit for communicating information from the eNB to UE, i.e. in downlink, or from the UE to the eNB, may be referred to as a block of resources, i.e. resource block. The resource block may be defined by a combination of time and frequency that forms a unit of resources which may be allocated for traffic. The frequency of the resource block may comprise one or more sub-carriers on the specific frequency band. Time of the resource block may comprise a unit of time in synchronized communications, for example a time slot.

In the context of LTE-A both uplink and downlink communications use 10 ms frame structure, where a single modulated symbol may be transmitted in each 1 ms sub-frame. The single sub-frame may be divided into 0.5 ms time slots. The downlink and uplink communications use Frequency Division Duplexing (FDD), whereby the downlink and uplink sub-carriers have their own sub-bands. Accordingly, in one example information of the usage the resources may comprise information of available sub-frames per a downlink or uplink sub-carrier.

In an embodiment, the eNB may calculate an estimate of its available capacity, e.g. in terms of available resources, on a specific frequency band. The frequency band may comprise for example the shared frequency band and/or another frequency band the eNB may use for communications. The available capacity may be communicated to other eNBs over an X2 interface, for example using a Composite Available Capacity (CAC) Information Element on X2 Application protocol, as described in Section 9.2.45 in the TS36.423 referenced above. The CAC IE indicates the overall available resource level in a cell in either downlink or uplink. Accordingly, the available resource in downlink and uplink may be communicated in separate messages between the eNBs.

The estimate of available capacity may be calculated on the basis of measurements performed on the shared frequency band. These measurements may be performed by UE as requested by an eNB, and they may include a Reference Signal Received Power (RSRP) and a Reference Signal Received Quality (RSRQ) measurement, as is conventional in the context of LTE-A.

In 304 interference coordination between the eNBs operating on the shared frequency band is performed. The interference coordination may comprise muting all or a part of the resource blocks in a specific time slot, a series of time slots, and/or a pattern of separate time slots. During the time one or more resource blocks are muted, communications under that eNB is performed at reduced power and/or at reduced activity. In this way the interference between the eNBs operating on the same frequency band may be reduced. Due to the interference coordination, the effective capacity available in the neighbouring macro, pico or femto cells is changed. In different embodiments the muting of resource blocks in a time slot may comprise reduced transmissions or no transmission during the time slot. The muting may also comprise transmissions that use reduced transmission power levels. Hence, it is possible to have at least three options for muting of resource blocks: no transmission of data signals but transmission of reference symbols (Almost Blank Subframes in TDM-eICIC defined below), transmission of data signals with reduced power (Low Power ABS, LP-ABS), and (3) no transmission of any signals at all (real blank subframes).

The interference coordination may comprise communicating between the eNBs one or more parameters of the interference coordination. The parameters may include information that identifies the one or more muted resource blocks.

In an embodiment, the interference coordination may comprise defining one or more muted resource blocks. The muted resource blocks may be defined by a time interval, during which resource blocks will be muted. The time interval may be defined by a sub-frame, for example. Then, sub-carriers during the sub-frame may be muted. It should be appreciated that it is possible that only a part of the sub-carriers are muted during a sub-frame. In one example, other sub-carriers than those including a reference signal, are muted. In another example, other sub-carriers than those that include control information such as System Information, are muted. In yet another example other sub-carriers than those including a reference signal and control information, are muted. When sub-carriers are muted, interference caused by a transmission by one of the eNBs to the other may be reduced.

An example of an interference coordination scheme, where resource blocks are muted, comprises an enhanced Inter-Cell Interference Coordination, eICIC, introduced in the 3GPP Release 10 specifications, Error! Use the Home tab to apply ZA to the text that you want to appear here., Section 16.1.5 Inter-cell Interference Coordination (ICIC), as a development of the ICIC schemes in Releases 8 and 9. The Release 10 specifications specify a time-domain eICIC (TDM-eICIC) to operate with time-domain muting by using almost blank subframes (ABS) where only common control channel data and common reference symbols (CRS) is transmitted. In the context of TDM-eICIC muting of resource blocks comprises muting all sub-carriers in selected sub-frames.

In an embodiment, the interference coordination may comprise adjusting a number of sub-carriers used by an eNB operating on the shared frequency band on the basis of the traffic to be served and the estimated interference generated to/from the neighbouring cells to the cells of the eNB. An example of an interference coordination scheme, where the number of used sub-carriers are adjusted comprises a Carrier Based (CB) eICIC schemes proposed for LTE Release 12 and beyond. In these proposals the interference is mitigated by dynamically, at a slow rate, adjusting a number of component carriers used by each eNB depending on the traffic to be served and the estimated interference generated to/from the neighbouring cells. In principle CB-eICIC can be applied to macro-pico, macro-macro, pico-pico, pico-femto or femto-femto configurations of eNBs.

In an embodiment, one or more parameters of the interference coordination may be communicated over an X2 interface between eNBs in an X2 Application protocol message. This message may include information of one or more sub-frames muted by the sending eNB. This information may be included in an Almost Blank Subframes Information Element including information about which sub frames the eNB is configuring as almost blank sub-frames and which subset of almost blank sub-frames are recommended for configuring measurements towards the UE, as defined in Section 9.2.54 in the TS36.423 reference above.

Muted resource blocks may be determined on the basis of information available in the eNB, which may include information of available capacity of the eNB and include for example Load in own-cell in terms of average number of used Physical Resource Blocks (PRBs). Also other information may be used, without limiting thereto, including Quality of Service parameters of UE served by the eNB, i.e. knowledge of requirements for each radio bearer, and statistical information of failed radio bearer establishments due to high load, and statistical information of capability of the eNB to meet the QoS parameters of the UE. The above information may be derived from control plane messaging related to establishment of connections, for example.

In an embodiment the interference coordination parameters comprise a bias, for example a range extension. The bias may be used in measurements for channel conditions on the shared frequency band, for example the RSRP and RSRQ performed by UE.

In 306 an estimate of available capacity of the eNB on the basis of the interference co-ordination may be determined. The capacity estimate may be a capacity estimate of a cell of the eNB. The interference coordination of step 304 changes the available capacity on the shared frequency in neighbouring eNBs that participate in the interference coordination. When the interference coordination comprises muting of resource blocks on the shared frequency band, available radio capacity is reduced on the shared frequency band in the eNB that mutes resource blocks. The actual served capacity by the muting eNB could be actually higher since due to the muting, UE may be handed over to one or more other eNBs from the muting eNB. Consequently, due to the handovers, more capacity is available to serve the traffic of the remaining UE at the muting eNB.

In an embodiment, eNBs operating on the shared frequency band comprise an eNB operating on a higher layer and an eNB on a lower layer, for example a macro layer eNB and an eNB providing a smaller coverage area, e.g. a micro layer, pico layer or a femto layer eNB. When interference coordination is used on the shared frequency band between the eNBs, the available capacity of the higher layer eNB on the shared frequency band is reduced, whereas the available capacity of the lower layer eNB is increased.

A capacity adjustment factor may be determined for the capacity estimate on the shared frequency band in the eNBs participating in the interference coordination.

An example implementation for determining a capacity adjustment factor for eNBs participating in interference coordination on the shared frequency band can be as follows:
A capacity adjustment (M_CACAdj) for a macro layer eNB may be calculated on the basis of a fraction of UE, i.e. a muting ratio, (ICIC_MR) served by the macro layer eNB, which are moved, e.g. via handover procedures, from the macro layer eNB to another eNB due to the use of interference coordination in the macro layer eNB. The destination eNB of the moved UE may be the pico layer eNB or another macro eNB. The number of moved UE may be determined on the basis of a comparison to changes in the served UE by the eNB before and after starting the interference coordination at the macro layer eNB. Then, the macro layer eNB capacity adjustment may be expressed as:

M_{—}CACAdj=1−ICIC_{—}MR (1)
[symbol] A capacity adjustment (P_CACAdj) for a pico layer eNB may be calculated on the basis of a fraction of UE (P_fUEICIC) experiencing high interference from the macro layer eNB. These UE may comprise the UE moved from the macro layer eNB to the pico layer eNB. The remaining UE served by the pico layer eNB may be expressed as:

[symbol]

1−P_{—}fUEICIC (2),
[symbol] Then the adjustment factor for the pico layer eNB may be expressed as a ratio:

P_{—}CACAdj=2/(P_{—}fUEICIC/ICIC_{—}MR+(1−P_{—}fUEICIC)/(1−ICIC_{—}MR)) (3) [symbol]
[symbol] The capacity estimate adjusted on the basis of the interference coordination may be determined for the macro layer eNB by multiplying the initial capacity estimate of the macro layer eNB by the M_CACAdj. Correspondingly, the capacity adjusted on the basis of the interference coordination may be determined for the pico layer eNB by multiplying the initial capacity estimate of the pico layer eNB by the P_CACAdj.

The above determined available capacity estimate that is adjusted on the basis of the interference coordination may be communicated between neighbouring eNBs, for example a macro layer eNB and the pico layer eNB, over the X2 interface. The neighbouring eNBs may be operating on the shared frequency band or another frequency band and can utilise received estimates of available capacity for handover and/or load balancing purposes.

It should be appreciated that, when an estimate of the available capacity is adjusted on the basis of the interference coordination, the accuracy of the available capacity estimate is increased.

In 308 the capacity estimate determined in 306 may be used to steer traffic between the eNBs operating on the shared frequency band and/or within an eNB between the shared frequency band and one or more other frequency bands of operation used by the eNB. In traffic steering it may be determined which frequency band has available capacity for serving received traffic and the received traffic is steered to that frequency band, where the traffic is scheduled resources for communicating it on towards its destination. The traffic may also involve steering of traffic between eNBs that may operate on the shared frequency band or eNBs operating on different frequency bands, e.g. the shared frequency band and another frequency band.

The traffic steering may be implemented by routing of traffic from one eNB to another, when the steering is performed between eNBs. When traffic is steered between different frequency bands within an eNB, the implementation may comprise switching traffic to a radio unit that communicates on the frequency band with available capacity. The traffic may be received as data symbols which are modulated by the radio unit for transmission on the frequency band.

The traffic may be steered between eNBs operating on the shared frequency band on the basis of information of available capacity on the shared frequency band received from other eNBs over an X2 interface. This received information may be compared with the capacity estimate determined at the eNB for the shared frequency band. In this way, traffic may be steered to the eNB that has capacity to serve it. Accordingly, the capacity determined in 306 may be used for intra-frequency band traffic steering between the eNBs.

In an embodiment, the traffic may be steered between a shared frequency band and one or more other operational frequency bands within a single eNB. The capacity estimate determined for the shared frequency band at the eNB may be compared with capacity estimates of the other frequency bands to determine which of the frequency bands can serve the traffic. Accordingly, the capacity determined in 306 may be used for inter-frequency band traffic steering within the eNB.

Since the traffic is steered on the basis of the more accurate estimate of available capacity determined in 306, parameters of the interference coordination may be adjusted with improved accuracy.

An example of traffic steering comprises load balancing between multiple cells as described in Section 16.1.6 of the TS 36.300 referenced above.

In 310 the available capacity is determined on the basis of interference coordination between neighbouring eNBs on the share frequency band and the method ends in 310. It should be appreciated that the method may be executed again, for example, when one or more parameters of the interference coordination are changed.

FIG. 4 illustrates adjustment of the available capacity estimates at neighbouring access nodes, when interference coordination on a shared frequency band is used between the access nodes, according to an embodiment.

The neighbouring access nodes may comprise eNBs of an LTE-A communications network, for example the network illustrated in FIG. 1. The eNBs may execute the process of FIG. 3.

The eNBs comprise a macro layer eNB and a pico layer eNB. The Macro layer eNB has two operational frequency bands of F1 at 800 MHz and F2 at 2600 MHz carrier frequencies. The pico layer eNB has a single operational frequency band F2 at the 2600 MHz carrier frequency. The frequency band F2 is a shared frequency band between the macro layer eNB and the pico layer eNB.

The macro layer eNB and the pico layer eNB participate in interference coordination. This may be performed as described in step 304 of FIG. 3. The available capacities of the macro layer eNB and the pico layer eNB on the shared frequency band may be determined on the basis of the interference coordination as described in the step 306 in the process of FIG. 3.

The macro layer eNB has an available capacity 402 on the shared frequency band F2 before interference coordination is performed. The interference coordination may comprise muting of resource blocks for example. Similarly, the pico layer eNB has an available capacity 408 on the shared frequency band F2 before interference coordination is performed. The determination of the available capacities at the macro layer eNB and the pico layer eNB may be performed on the basis of, e.g. in terms of available resources, as is conventional.

When interference coordination is performed, the available capacities of the macro layer eNB and the pico layer eNB are changed 404, 406. An adjustment factor may be calculated for the capacity of the macro layer eNB on the shared frequency band on the basis of the change caused to the capacity by the interference coordination. An adjustment factor may be calculated for the capacity of the pico layer eNB on the shared frequency band on the basis of the change caused to the capacity by the interference coordination. The calculation may be performed as described with step 306 in FIG. 3. In this way estimates of available capacity on the shared frequency band at the macro layer eNB and the pico layer eNB may be obtained.

The estimates of the available capacities of the macro layer eNB and the pico layer eNB on the shared frequency band may be used in traffic steering 410. The traffic steering may comprise traffic steering 414 between the macro layer and pico layer eNBs, i.e. inter-layer and intra-frequency traffic steering and/or traffic steering 412 between the operational frequency bands of a single eNB, inter-frequency intrasite traffic steering. The capacity estimates may be communicated 414 between the eNBs over an X2 interface to provide adjusted capacity estimates for the traffic steering.

It should be appreciated that although the above embodiments have been described by referring to an access node that provides radio access in a wireless communications system, and an operational frequency band of the access node, the described embodiments may be applied also cells that are engaged in interference coordination and operating on a shared frequency band between the cells.

In an embodiment one or more parameters of interference coordination are changed. These parameters may include information of muted resource blocks. The changed parameters may be communicated between eNBs. When information of the changed parameters is received, it may be determined that an available capacity estimate for a shared frequency band should be adjusted. This adjustment may be performed as described above with the process of FIG. 3.

It should be appreciated that the above embodiments may be performed at an initial stage of interference coordination, where a capacity estimate of a shared frequency band may be adjusted with information of the interference coordination. In this way changes in available capacity on the shared frequency band at an eNB may be considered in the capacity estimate and further in steering of traffic between eNBs. In different embodiments, an eNB may be connected to two or more, i.e. a plurality, of eNBs that are performing interference coordination on a shared frequency band. The eNB may operate on a different frequency band than the other eNBs. The connection may be e.g. an X2 connection. Then the eNB operating on the different frequency band may determine one or more capacity estimates on the basis of the interference co-ordination by receiving the determined capacity estimates on the X2 interface from the other eNBs that may be performing one or more steps of the method illustrated in FIG. 3.

The received capacity estimates may be used for steering traffic in the eNB, for example as defined in TS 36.300 Section 16.1.6 referenced above. Accordingly, capacity estimates determined on the basis of the interference coordination may be used for traffic steering also in eNBs that are operating on a different frequency band than the frequency band, where the interference coordination measures are performed, e.g. muting of resource blocks. Furthermore, the capacity estimates may facilitate traffic steering in eNBs that are connected, but not necessarily neighbouring the eNBs that operate on the shared frequency band and whose capacity is changed by the interference coordination measures on the shared frequency band. The eNBs may operate on the same layer, e.g. they may be macro layer eNBs or they may operate on different layers of a wireless communications network. The steps/points and related functions described above in FIG. 3 are in no absolute chronological order, and some of the steps/points may be performed simultaneously or in an order differing from the given one. Other functions can also be executed between the steps/points or within the steps/points, and other signalling messages may be sent between the illustrated messages, and other transmissions of data may be sent between the illustrated transmissions. Some of the steps/points or part of the steps/points can also be left out or replaced by a corresponding step/point or part of the step/point.

The techniques described herein may be implemented by various means so that an apparatus implementing one or more functions described with an embodiment comprises not only prior art means, but also means for implementing interference coordination between at least two neighbouring access nodes operating on a shared frequency band in a wireless communications network, determining a capacity estimate of an access node of the wireless communications network on the basis of the interference co-ordination, and allocating traffic on the basis of the determined capacity estimate.

More precisely, the various means comprise means for implementing functionality of a corresponding apparatus described with an embodiment and it may comprise separate means for each separate function, or means may be configured to perform two or more functions. For example, these techniques may be implemented in hardware (one or more apparatuses), firmware (one or more apparatuses), software (one or more modules), or combinations thereof. For a firmware or software, implementation can be through modules (e.g., procedures, functions, and so on) that perform the functions described herein. The software codes may be stored in any suitable, processor/computer-readable data storage medium(s) or memory unit(s) or article(s) of manufacture and executed by one or more processors/computers. The data storage medium or the memory unit may be implemented within the processor/computer or external to the processor/computer, in which case it can be communicatively coupled to the processor/computer via various means as is known in the art.

1. A method comprising:
performing interference coordination between at least two neighbouring access nodes operating on a shared frequency band in a wireless communications network;
determining a capacity estimate of an access node of the wireless communications network on the basis of the interference co-ordination; and
steering traffic on the basis of the determined capacity estimate.

2. A method according to claim 1, comprising:
receiving at least one interference coordination parameter used by an access node operating on the shared frequency band;
determining a capacity estimate on the basis of information of the received at least one interference coordination parameter.

3. A method according to claim 1, wherein at least one of the access nodes operate on the shared frequency band and a different frequency band that is higher than the shared frequency band, the method comprising:
receiving at least one interference coordination parameter from the access node operating on the different frequency band; and
determining an increase of capacity in an access node operating on the shared frequency band on the basis of the received at least one interference coordination parameter.

4. A method according to claim 1, wherein the at least one interference coordination parameter comprises a muting pattern for physical resource blocks on the shared frequency band, and the method comprises:
determining the capacity estimate on the basis of the muted physical resource blocks of the at least one of the access nodes.

5. A method according to claim 1, wherein the interference coordination parameters comprises a bias, for example a range extension, for measuring channel conditions on the shared frequency band, whereby the capacity estimate is determined on the basis of results of performing one or more of the biased measurements.

6. A method according to claim 1, wherein at least one of the access nodes operate on the shared frequency band and a different frequency band that is higher than the shared frequency band, the method comprising:
receiving at the access node operating on the different frequency band at least one interference coordination parameter from as access node operating on the shared frequency band; and
steering traffic between the different frequency band and the shared frequency band on the basis of the determined capacity.

7. A method according to claim 1, wherein the access nodes operating on the shared frequency band comprise evolved NodeBs.

8. A method according to claim 1, wherein the access nodes operating on the shared frequency band comprise at least two or more from a group comprising: an access node providing a large coverage area, for example a macro layer eNB, and an access node providing a smaller coverage area, for example a micro, pico, or femto layer eNB.

9. A method according to claim 1, wherein the steering comprises scheduling time and frequency resources on a frequency band for communicating the traffic.

10. A method according to claim 1, wherein the steering comprises communicating the determined capacity to at least one neighbouring access node participating in the interference coordination.

11. An apparatus comprising means configured to perform a method according to claim 1.

12. A computer program comprising program code means adapted to perform the steps of claim 1 when the program is run on a computer or on a processor.

13. A communications system comprising at least two apparatuses according to claim 11.
